(19) United States
(12) Patent Application Publication
(10) Pub. No.: US 2010/0039676 A1
(43) Pub. Date: Feb. 18, 2010

(54) Relevant Messages Associated with Incoming Fax Documents Using Multiple Facsimiles

(75) Inventors: Michael Jonathan Noel, Phoenix, AZ (US); Lucas Mooney, Scottsdale, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/605,112

(22) Filed: Oct. 23, 2009

Related U.S. Application Data
(62) Division of application No. 11/164,351, filed on Nov. 18, 2005.

(51) Int. Cl. H04N 1/00; H04N 1/32; G06F 17/30

(52) U.S. Cl. 358/402; 358/442; 707/7

(57) ABSTRACT

Systems and methods of the present invention allow for incorporation of relevant messages, such as commercial advertisements, in incoming faxes and/or for presentation of relevant messages with incoming faxes. Text may be extracted from a current and/or previously sent or received facsimile, using, for example, Optical Character Recognition (OCR), and relevant messages may be added in the facsimile. A sample embodiment of the system comprises a Receiving Means, an Extracting Means, an Analyzing Means, a Storing Means, a Selecting Means, an Incorporating Means, a Converting Means, and a Delivering Means. An alternative sample embodiment comprises a Receiving Means, an Extracting Means, an Incorporating Means, and a Delivering Means. The systems may be maintained by a Fax Server Provider. A sample embodiment of the method comprises the steps of receiving a facsimile intended for a Recipient, extracting text from the facsimile, incorporating one or more relevant messages in the facsimile, and delivering the facsimile to the Recipient.

### CROSS REFERENCE TO RELATED PATENT APPLICATIONS

The present application is a divisional of U.S. patent application Ser. No. 11/164,351, “Relevant Messages Associated with Incoming Fax Documents,” filed Nov. 18, 2005, which is incorporated hereby in its entirety by reference.

The present application is related to the U.S. patent application Ser. No. 11/164,349, “Relevant Messages Associated with Outgoing Fax Documents,” filed Nov. 18, 2005, which is incorporated hereby in its entirety by reference.

The present application is related to the following patent applications concurrently filed herewith, all assigned to The Go Daddy Group, Inc, and incorporated hereby in their entirety by reference:

U.S. patent application Ser. No. ______, “Relevant Messages Associated with Outgoing Fax Documents Using Multiple Facsimiles.”

U.S. patent application Ser. No. ______, “Relevant Messages Associated with Outgoing Fax Documents Using Previous Facsimile.”

U.S. patent application Ser. No. ______, “Relevant Messages Associated with Incoming Fax Documents Using Previous Facsimile.”

U.S. patent application Ser. No. ______, “Presenting Relevant Messages Associated with Incoming Fax Documents.”

U.S. patent application Ser. No. ______, “Presenting Relevant Messages Associated with Incoming Fax Documents Using Multiple Facsimiles.”

U.S. patent application Ser. No. ______, “Presenting Relevant Messages Associated with Incoming Fax Documents Using Previous Facsimile.”

### FIELD OF THE INVENTION

The present invention relates in general to facsimile systems and methods and in particular to placing messages (such as advertisements) on facsimile documents or presenting messages with facsimile documents.

### BACKGROUND OF THE INVENTION

Facsimile (or fax) technology is one of the most widely used forms of communication between companies and individuals. Notwithstanding the continuous growth of the popularity of email communications, the fax still holds a strong position as a reliable means of communication. It is presently estimated that more companies in the world have a fax number than an email address.

Among the advantages of fax communications are immediate delivery of documents, ability to transmit graphical documents, interoperability of fax devices throughout the world, improved security over email, and easy to use.

Traditional fax technology utilizes Public Switched Telephone Network (PSTN), also called Global Switched Telephone Network (GSTN), to transfer data between fax devices. Traditional fax devices comply with a variety of protocols, among which are: T.4—“Standardization of Group 3 Facsimile Apparatus for Document Transmission”, ITU-T (CCITT), July 1996; T.6—“Facsimile Coding Schemes and Coding Control Functions for Group 4 Facsimile Apparatus”, ITU-T (CCITT), November 1988; and T.30—“Procedures for Document Facsimile Transmission in the General Switched Telephone Network”, ITU-T (CCITT), July 1996; all are hereby incorporated in their entirety by reference.

Internet Fax (I-Fax) is a term used to describe extensions of the traditional fax technology that allow the use of the Internet for fax transmission. Examples of I-Fax are fax-over-IP and fax-through-email. Among the standards recommended for use in I-Fax are: T.37—“Procedures for the transfer of facsimile data via store-and-forward on the Internet”, ITU-T (CCITT), June 1998; T.38—“Procedures for real-time Group 3 facsimile communication over IP networks”, ITU-T (CCITT), 1998; F.185—“Internet facsimile: Guidelines for the support of the communication of facsimile documents”, ITU-T (CCITT), 1998; RFC 2301—“File Format for Internet Fax”, IETF, March 1998; RFC 2302—“Tag Image File Format (TIFF)—image/tiff MIME Sub-type Registration”, IETF, March 1998; RFC 3191—“Minimal GSTN address format in Internet Mail”, IETF, October 2001 (obsoletes RFC 2303, March 1998; updates RFC 2846, June 2000); RFC 3192—“Minimal FAX address format in Internet Mail”, IETF, October 2001 (obsoletes RFC 2304, March 1998; updates RFC 2846, June 2000); RFC 3965—“A Simple Mode of Facsimile Using Internet Mail”, IETF, December 2004 (obsoletes RFC 2305, March 1998); RFC 2306—“Tag Image File Format (TIFF)—F Profile for Facsimile”, IETF, March 1998; RFC 2542—“Terminology and Goals for Internet Fax”, IETF, March 1999; and RFC 3297—“Content Negotiation for Messaging Services based on Email”, IETF, July 2002; all are hereby incorporated in their entirety by reference.

Advanced capabilities of Internet Fax, such as color fax transmissions, are described, inter alia, in RFC 2531—“Content Feature Schema for Internet Fax”, IETF, March 1999 and RFC 2532—“Extended Facsimile Using Internet Mail”, IETF, March 1999; all are hereby incorporated in their entirety by reference.

In a conventional fax-through-email system, a fax service provider receives a fax transmission over the PSTN, converts the received fax transmission to a computer-readable file, e.g. TIFF or PDF (Portable Document Format), and forwards the file to the intended fax recipient via email. If a user sends a fax, the user provides document(s) to be faxed to the fax service provider via email, website, or software. The documents typically are computer-readable files. The fax service provider converts the document(s) to a faxable format (typically 1-bit black and white images), and transmits them to the recipient over the PSTN.

Typically, fax service providers charge their users a monthly fee and/or usage fees. The usage fees may be based on the number of minutes used to send and/or receive fax documents or the number of pages sent and/or received. Some fax service providers may offer their service for free or at a discount if a fax sender and/or a fax recipient agree to the placement of an advertisement on the fax document by the fax service provider. However, these arrangements are not very common.

U.S. Pat. No. 5,513,254 issued to Markowitz on Apr. 30, 1996 describes a method and apparatus for incorporating advertisements with the facsimile, where the advertisements are independent of the content of the facsimile or may be selected as a function of one or more parameters of the call over which the facsimile transmission travels. U.S. Pat. No. 6,564,193 issued to Shore, et al. on May 13, 2003 describes a system and method for providing fax service to the users via a website, where the advertisements may be incorporated with the facsimile if the sender chooses the free transmission option. U.S. Pat. Nos. 5,513,254 and 6,564,193 are incorporated hereby in their entirety by reference.

There are many fax service providers available on the market. Due to extensive competition, profit margins of the fax service providers are not very high.

Therefore, new systems and methods are needed to provide customers with discounted or free fax services and to improve profitability of fax service providers through new streams of income.

### SUMMARY OF THE INVENTION

The systems and methods of the present invention allow for incorporating relevant messages and/or presenting relevant messages with facsimile documents. The relevancy of the messages is determined based on the currently sent or received facsimile, previously sent or received facsimile, and/or Sender's and/or Receiver's properties.

A sample embodiment of the invention discloses a system comprising a Sender sending a facsimile to a Recipient, wherein the Sender is using a Fax Service Provider (FSP). The FSP maintains a Fax Server comprising a Means for Obtaining documents to be faxed from the Sender, a Means for Extracting text from documents to be faxed, a Means for Analyzing the extracted text and/or Sender's properties, a Means for Storing messages (e.g. ads) to be incorporated with the facsimile, a Means for Selecting relevant messages to be incorporated with the facsimile based on the extracted text and/or Sender's properties, a Means for Incorporating relevant messages with the facsimile, a Means for Converting the facsimile to a fax-compliant format, and a Means for Transmitting the facsimile to the Recipient.

An alternative embodiment of the invention discloses a system comprising a Sender sending a facsimile to a Recipient, wherein the Recipient is using a FSP. The FSP maintains a Fax Server comprising a Means for Receiving a facsimile from the Sender, a Means

A sample method of the invention may comprise the following steps. One or more documents may be obtained from a Sender. The Sender may be validated. Sender's properties may be determined. Text may be extracted from the documents to be faxed. The extracted text and the Sender's properties may be analyzed. One or more relevant messages (ads) may be selected to be placed into the fax. One or more relevant messages (ads) may be incorporated with the document(s) to be faxed. The document(s) may be converted to a fax-compliant format. The document(s), with one or more incorporated messages (ads), may be transmitted to a Recipient.

Another sample method of the invention may comprise the following steps. One or more fax documents intended for a Recipient may be received. Recipient's properties may be determined. Text may be extracted from the fax document(s). The extracted text and the Recipient's properties may be analyzed. One or more relevant messages (ads) may be selected to be placed into the fax document(s). One or more relevant messages (ads) may be incorporated with the fax document(s). The document(s) may be converted to one or more computer files. The computer files(s), with one or more incorporated messages (ads), may be delivered to the Recipient.

Additionally or alternatively, unincorporated messages (ads) may be presented to the Recipient.

### BRIEF DESCRIPTION OF THE DRAWINGS

FIG. 1 is a block diagram illustrating a sample embodiment of the system of the present invention.

FIG. 2 is a block diagram illustrating another sample embodiment of the system of the present invention.

FIG. 3 is a block diagram illustrating a sample embodiment of a Sender's Fax Server of FIG. 1.

FIG. 4 is a block diagram illustrating a sample embodiment of a Recipient's Fax Server of FIG. 2.

FIG. 5 is a flowchart illustrating a sample embodiment of the method of the present invention.

FIG. 6 is a flowchart illustrating another sample embodiment of the method of the present invention.

FIG. 7 is a block diagram illustrating another sample embodiment of the Sender's Fax Server of FIG. 1.

FIG. 8 is a block diagram illustrating another sample embodiment of the Recipient's Fax Server of FIG. 2.

FIG. 9 is a flowchart illustrating another sample embodiment of the method of the present invention.

FIG. 10 is a flowchart illustrating another sample embodiment of the method of the present invention.

FIG. 11 illustrates various sample placements of the message(s) in the document(s).

FIG. 12 is a block diagram illustrating another sample embodiment of the Recipient's Fax Server of FIG. 2.

FIGS. 13 and 14 are flowcharts illustrating other sample embodiments of the method of the present invention.

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

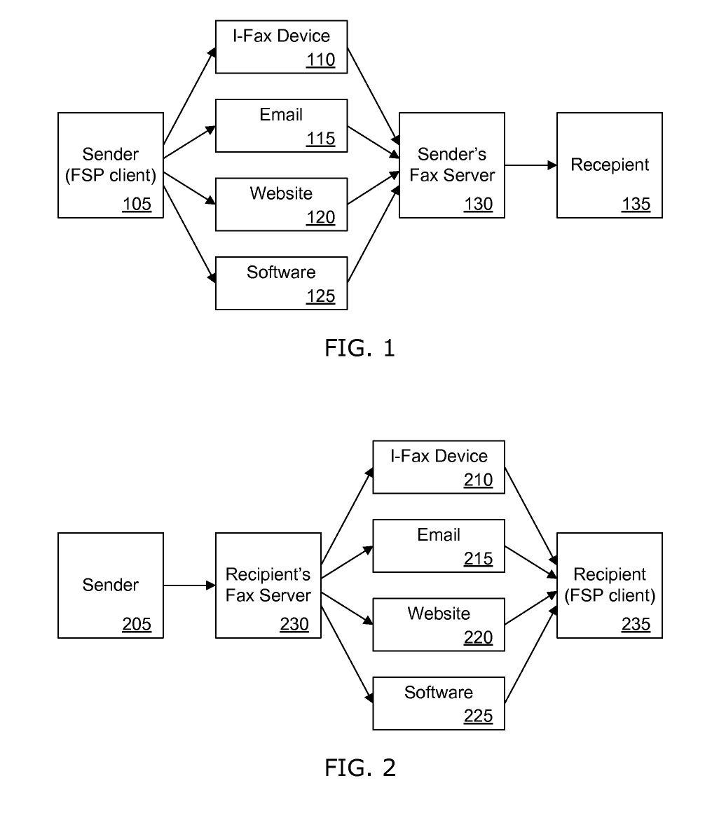

A sample system of the present invention is illustrated in FIG. 1. The system may comprise a Sender 105, who is a client of a Fax Service Provider (FSP), a Sender's Fax Server 130, and a Recipient 135. The FSP may obtain one or more documents to be faxed from the Sender 105 to the Recipient 135 via a computer network. The documents may be transmitted from the Sender 105 to the Sender's Fax Server 130 via an I-Fax Device 110, an Email 115, a Website 120, and/or a Software 125. The documents to be faxed may be electronic files in various formats, such as text, HTML (HyperText Markup Language), PDF (Portable Document Format), Microsoft Word®, Microsoft Excel®, Corel WordPerfect®, Corel Quattro Pro®, BMP (Bitmap Picture), TIFF (Tagged Image File Format), JPEG, GIF, PNG, etc. The documents to be faxed may contain text and/or graphics.

The I-Fax Device 110 is an I-Fax-compliant device that provides transmission of electronic fax data between the Sender 105 and the Sender's Fax Server 130 via a computer network, thus avoiding traditional fax transmission via a telephone network.

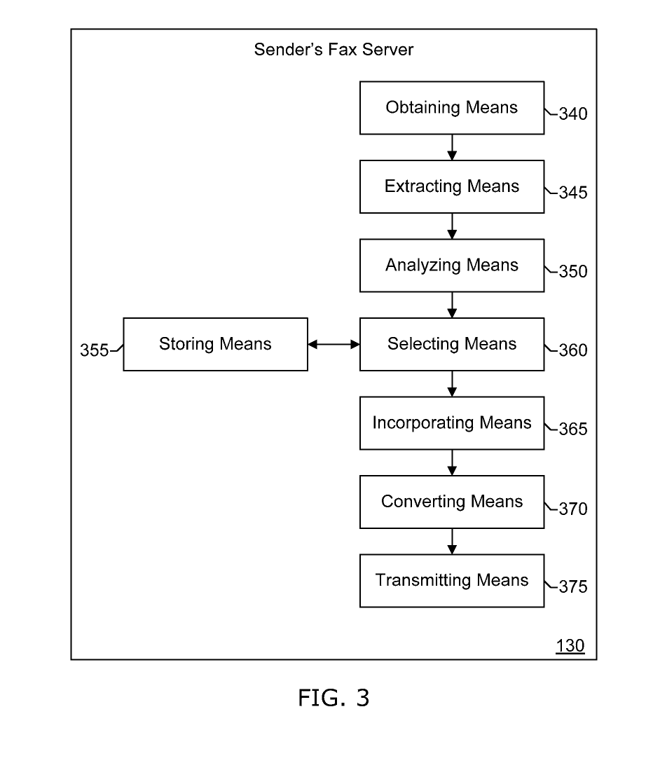

Referring to FIG. 3, a sample embodiment of the Sender's Fax Server 130 may comprise a Means for Obtaining the documents to be faxed from the Sender 105 (Obtaining Means 340), a Means for Extracting text from the documents to be faxed (Extracting Means 345), a Means for Analyzing the extracted text and/or Sender's properties (Analyzing Means 350), a Means for Storing one or more messages (e.g. ads) to be incorporated with a facsimile (Storing Means 355), a Means for Selecting one or more relevant messages to be incorporated with the facsimile (Selecting Means 360), a Means for Incorporating relevant messages with the documents (Incorporating Means 365), a Means for Converting the documents to a fax-compliant format (Converting Means 370), and a Means for Transmitting the facsimile to the Recipient 135 (Transmitting Means 375).

The Obtaining Means 340 is one or more computers, devices, routers, hubs, circuitry, and/or hardware, or equivalents thereof, optionally programmed with logical instructions, for obtaining one or more documents from the Sender 105.

The Extracting Means 345 is one or more computers, devices, circuitry, and/or hardware, or equivalents thereof, optionally programmed with logical instructions, for extracting text from one or more documents. The Extracting Means 345 may use Optical Character Recognition (OCR), Intelligent Character Recognition (ICR), and/or similar text recognition technology.

The Analyzing Means 350 is one or more computers, devices, circuitry, and/or hardware, or equivalents thereof, optionally programmed with logical instructions, for analyzing the extracted text and/or the Sender's properties.

The Storing Means 355 is one or more computers, devices, circuitry, and/or hardware, or equivalents thereof, optionally programmed with logical instructions, for storing one or more messages (e.g. ads) and/or other data. Storing Means 355 may be a database.

The Selecting Means 360 is one or more computers, devices, circuitry, and/or hardware, or equivalents thereof, optionally programmed with logical instructions, for selecting one or more relevant messages to be incorporated with the facsimile.

The Selecting Means 360 selects the relevant messages to be incorporated with the facsimile based on the text extracted from the documents to be faxed, and/or based on text extracted from previously sent and/or received facsimile, and/or based on the Sender's properties. The Sender's properties are the information associated with a Sender's account at the FSP. The Sender's properties may include a Sender's fax number, geographical location, email address, preferences, previously sent and/or received facsimile, etc. The Sender's geographical location may be determined from the Sender's fax number or may be already on record with the FSP. The Sender's previously sent and/or received facsimile may provide terms, keywords, key-phrases, topics, and/or categories that may be used to determine relevant messages (ads) for current fax transmission. In addition to the extracted text and the Sender's properties, the Selecting Means 360 may use Recipient's properties to provide a better selection of the relevant messages. The Recipient's properties may include a Recipient's fax number, geographical location, name, previously sent and/or received facsimile, etc. The Recipient's geographical location may be determined from the Recipient's fax number or may be already on record with the FSP. The Recipient's previously sent and/or received facsimile may provide terms, keywords, key-phrases, topics, and/or categories that may be used to determine relevant messages (ads) for current fax transmission.

The Incorporating Means 365 is one or more computers, devices, circuitry, and/or hardware, or equivalents thereof, optionally programmed with logical instructions, for incorporating relevant messages with the facsimile.

The Converting Means 370 is one or more computers, devices, circuitry, and/or hardware, or equivalents thereof, optionally programmed with logical instructions, for converting the documents to a fax-compliant format.

The Transmitting Means 375 is one or more computers, devices, routers, hubs, circuitry, and/or hardware, or equivalents thereof, optionally programmed with logical instructions, for transmitting the facsimile to the Recipient 135. The Transmitting Means 375 may transmit the facsimile to the Recipient 135 via telephone lines, Internet, or other communication pathways.

The Obtaining Means 340, the Extracting Means 345, the Analyzing Means 350, the Storing Means 355, the Selecting Means 360, the Incorporating Means 365, the Converting Means 370, the Transmitting Means 375, or any combination thereof may be physically implemented on a single computer, device, router, hub, circuitry, and/or hardware, or equivalents thereof.

Further, the Storing Means 355 may store terms, keywords, key-phrases, topics, and/or categories associated with the messages (ads). If the terms, keywords, and/or key-phrases are found in the extracted text, or topics and/or categories may be associated with the extracted text, then the messages associated with such terms, keywords, key-phrases, topics, and/or categories may be considered relevant.

Further, the Storing Means 355 may store geographical location data associated with the messages (ads). The relevance of the message (ad) may further be a function of a distance between geographical location associated with the message and the Sender's or/and Recipient's geographical location.

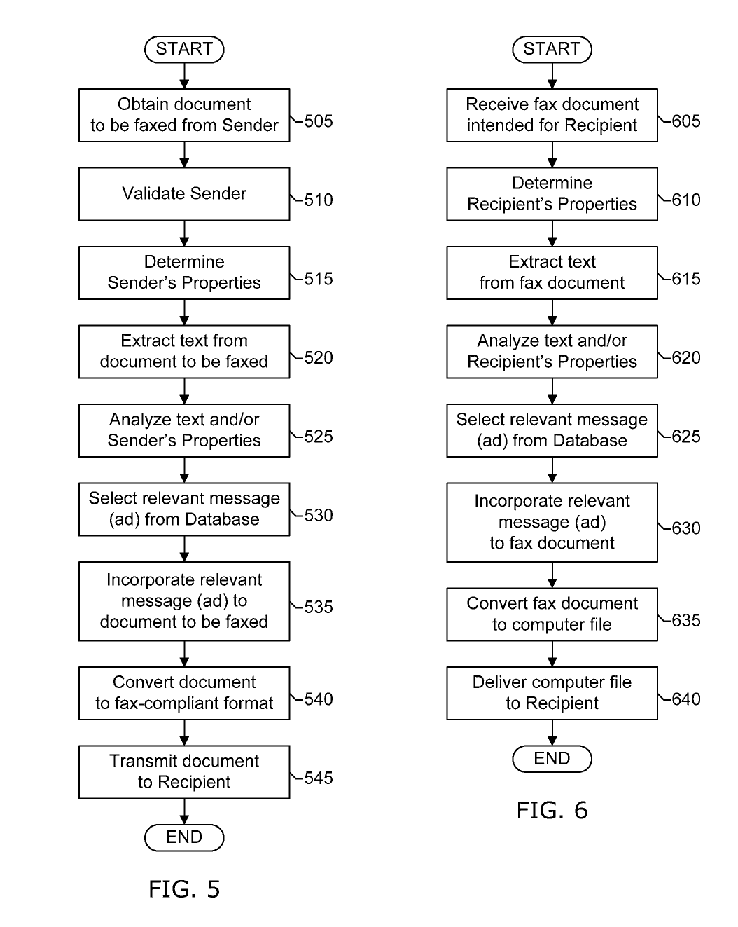

A sample method for incorporating relevant messages (ads) with an outgoing facsimile is shown in FIG. 5. One or more documents may be obtained from a Sender (Step 505). The document(s) may be obtained from the Sender through a variety of mediums, such as an I-Fax-compliant device able to transmit the documents to the FSP, an email, a website where the Sender may post his/her documents or type the text of a fax message, a software that transmits the documents to the FSP, any combination thereof, equivalents thereof, and other mediums.

The Sender may be validated (Step 510). Validating the Sender ensures identity of a person sending the fax. Sender's properties may be determined (Step 515). The Sender's properties may be obtained from the Sender's account with a FSP. Text may be extracted from the documents to be faxed (Step 520). The extracted text and the Sender's properties may be analyzed (Step 525). The analysis may include detecting the most significant terms, keywords, key-phrases, topics, and/or categories in the documents that will be used to find relevant messages (ads). One or more relevant messages (ads) may be selected to be placed into the fax (Step 530).

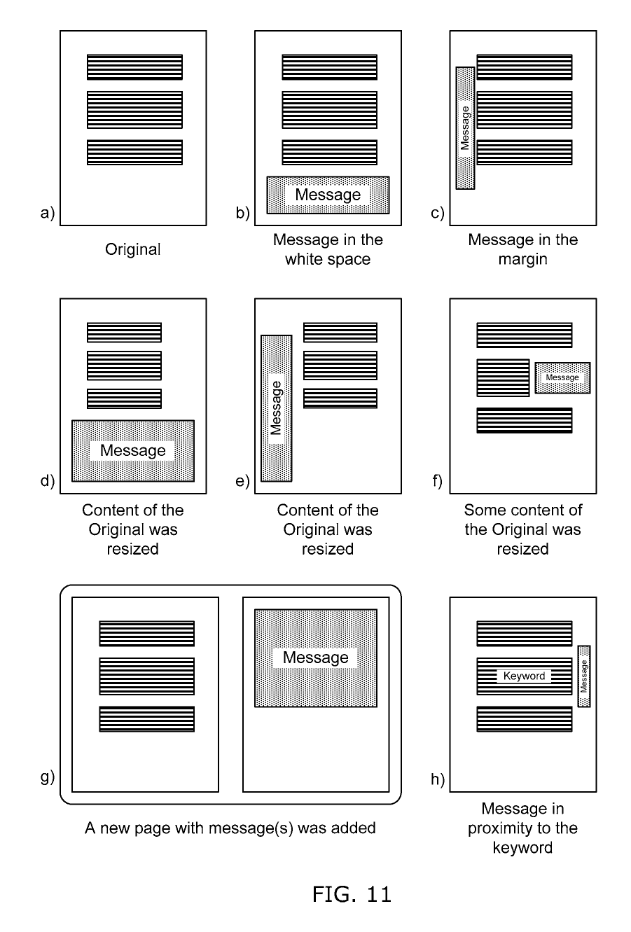

One or more relevant messages (ads) may be incorporated with the document(s) to be faxed (Step 535). The messages (ads) may be incorporated with the document(s) by adding one or more pages with the messages to the document(s), by placing the messages into a white space of the document(s), by placing the messages in the page margins of the document(s), by resizing some or all content of the document(s) and placing the messages into a white space, by placing the messages on the page(s) as watermarks, and/or by other methods. Additionally, the messages (ads) may be positioned in proximity to the significant terms, keywords, key-phrases, topics, and/or categories that were used to select the relevant message. The proximity may mean that the message is placed on the same page, or with a particular distance from the keyword (or a paragraph where it appeared), or on a white space closely located to the keyword (or closely located to a paragraph where the keyword appeared). If there are multiple white spaces in proximity to the keyword (or paragraph), the largest white space may be used. FIG. 11 illustrates various sample placements of the message in the document. The messages (ads) may contain text and/or graphics. Some messages may be comprised of a single graphic. The messages may be resized to fit in the white spaces, page margins, or on the pages.

Further, the document(s) may be converted to a fax-compliant format (Step 540). As part of the conversion, the document(s) may be converted to a monochrome format. Additionally, as part of the conversion, the document(s) may be converted to a TIFF format. The document(s), with one or more incorporated messages (ads), may be transmitted to a Recipient (Step 545). The document(s) may be transmitted via PSTN and/or Internet channels.

The steps of the method described in FIG. 5 may be performed in a different order. For example the Sender may be first validated (Step 510) and then one or more documents may be obtained from the Sender (Step 505).

Alternatively, the messages (ads) may be incorporated into the document(s) after the document(s) was/were converted into a fax-compliant format.

Additionally and/or alternatively, the relevancy of the messages may be determined based on text extracted from a previously sent and/or received facsimile, and/or based on the Sender's and/or Recipient's properties of a previously sent and/or received facsimile.

Additionally, the document(s) and/or message(s) may be optimized as described in U.S. patent application Ser. No. 11/162,379 entitled Document color and shades of gray optimization using solid monochrome colors, U.S. patent application Ser. No. 11/162,382 entitled Document color and shades of gray optimization using dithered monochrome surfaces, U.S. patent application Ser. No. 11/162,385 entitled Document color and shades of gray optimization using monochrome patterns, and U.S. patent application Ser. No. 11/162,390 entitled Document color and shades of gray optimization using outlining; all are incorporated herein in their entirety by reference.

Another sample system of the present invention is illustrated in FIG. 2. The system may comprise a Sender 205, a Recipient's Fax Server 230, and a Recipient 235, who is a client of a Fax Service Provider (FSP). The FSP may receive one or more fax documents from the Sender 205, convert them to one or more computer files and deliver the computer files to the Recipient 235 via a computer network. The computer files may be transmitted from the Recipient's Fax Server 230 to the Recipient 235 via an I-Fax Device 210, an Email 215, a Website 220, and/or a Software 225. The computer files may be in various formats, such as PDF (Portable Document Format), BMP (Bitmap Picture), TIFF (Tagged Image File Format), JPEG, GIF, PNG, etc.

The I-Fax Device 210 is an I-Fax-compliant device that provides transmission of electronic fax data between the Recipient's Fax Server 230 to the Recipient 235 via a computer network, thus avoiding traditional fax transmission via a telephone network.

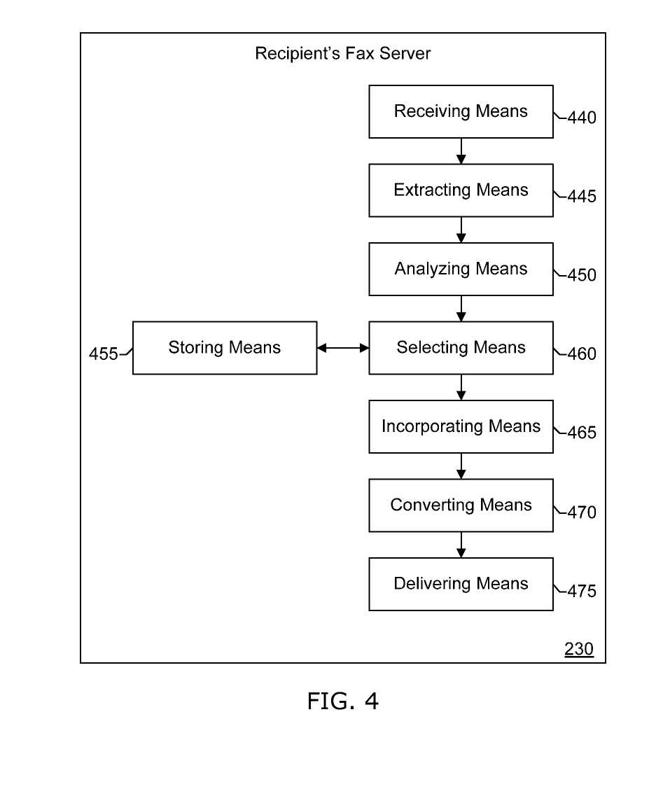

Referring to FIG. 4, a sample embodiment of the Recipient's Fax Server 230 may comprise a Means for Receiving facsimile document(s) (transmissions) from the Sender 205 (Receiving Means 440), a Means for Extracting text from the facsimile documents (Extracting Means 445), a Means for Analyzing the extracted text and/or Recipient's properties (Analyzing Means 450), a Means for Storing one or more messages (e.g. ads) to be incorporated with the facsimile documents (Storing Means 455), a Means for Selecting one or more relevant messages to be incorporated with the facsimile documents (Selecting Means 460), a Means for Incorporating relevant messages with the facsimile documents (Incorporating Means 465), a Means for Converting the facsimile documents to computer files (Converting Means 470), and a Means for Delivering the computer files to the Recipient 235 (Delivering Means 475).

The Receiving Means 440 is one or more computers, devices, routers, hubs, circuitry, and/or hardware, or equivalents thereof, optionally programmed with logical instructions, for receiving one or more facsimile documents (transmissions) from the Sender 205.

The Extracting Means 445 is one or more computers, devices, circuitry, and/or hardware, or equivalents thereof, optionally programmed with logical instructions, for extracting text from one or more facsimile documents. The Extracting Means 445 may use Optical Character Recognition (OCR), Intelligent Character Recognition (ICR), and/or similar text recognition technology.

The Analyzing Means 450 is one or more computers, devices, circuitry, and/or hardware, or equivalents thereof, optionally programmed with logical instructions, for analyzing the extracted text and/or the Recipient's properties.

The Storing Means 455 is one or more computers, devices, circuitry, and/or hardware, or equivalents thereof, optionally programmed with logical instructions, for storing one or more messages (e.g. ads) and/or other data. Storing Means 455 may be a database.

The Selecting Means 460 is one or more computers, devices, circuitry, and/or hardware, or equivalents thereof, optionally programmed with logical instructions, for selecting one or more relevant messages to be incorporated with the facsimile documents.

The Selecting Means 460 selects the relevant messages to be incorporated with the facsimile documents based on the text extracted from the facsimile documents, and/or based on text extracted from previously sent and/or received facsimile, and/or based on the Recipient's properties. The Recipient's properties are the information associated with a Recipient's account at the FSP. The Recipient's properties may include a Recipient's fax number, geographical location, email address, preferences, previously sent and/or received facsimile, etc. The Recipient's geographical location may be determined from the Recipient's fax number or may be already on record with the FSP. The Recipient's previously sent and/or received facsimile may provide terms, keywords, key-phrases, topics, and/or categories that may be used to determine relevant messages (ads) for current fax transmission. In addition to the extracted text and the Recipient's properties, the Selecting Means 460 may use Sender's properties to provide a better selection of the relevant messages. The Sender's properties may include a Sender's fax number, geographical location, name, previously sent and/or received facsimile, etc. The Sender's geographical location may be determined from the Sender's fax number or may be already on record with the FSP. The Sender's previously sent and/or received facsimile may provide terms, keywords, key-phrases, topics, and/or categories that may be used to determine relevant messages (ads) for current fax transmission.

The Incorporating Means 465 is one or more computers, devices, circuitry, and/or hardware, or equivalents thereof, optionally programmed with logical instructions, for incorporating relevant messages with the facsimile documents.

The Converting Means 470 is one or more computers, devices, circuitry, and/or hardware, or equivalents thereof, optionally programmed with logical instructions, for converting the fax documents to the computer files.

The Delivering Means 475 is one or more computers, devices, routers, hubs, circuitry, and/or hardware, or equivalents thereof, optionally programmed with logical instructions, for delivering the computer files to the Recipient 235 or otherwise presenting the facsimile to the Recipient 235. The Delivering Means 475 may deliver the computer files to the Recipient 235 via a computer network.

The Receiving Means 440, the Extracting Means 445, the Analyzing Means 450, the Storing Means 455, the Selecting Means 460, the Incorporating Means 465, the Converting Means 470, the Delivering Means 475, or any combination thereof may be physically implemented on a single computer, device, router, hub, circuitry, and/or hardware, or equivalents thereof.

Further, the Storing Means 455 may store terms, keywords, key-phrases, topics, and/or categories associated with the messages (ads). If the terms, keywords, and/or key-phrases are found in the extracted text, or topics and/or categories may be associated with the extracted text, then the messages associated with such terms, keywords, key-phrases, topics, and/or categories may be considered relevant.

Further, the Storing Means 455 may store geographical location data associated with the messages (ads). The relevance of the message (ad) may further be a function of a distance between the geographical location associated with the message and the Sender's or/and Recipient's geographical location.

A sample method for incorporating relevant messages (ads) with an incoming facsimile is shown in FIG. 6. One or more fax documents intended for a Recipient may be received (Step 605). Recipient's properties may be determined (Step 610). The Recipient's properties may be obtained from the Recipient's account with a FSP. Text may be extracted from the fax document(s) (Step 615). The extracted text and the Recipient's properties may be analyzed (Step 620). The analysis may include detecting the most significant terms, keywords, key-phrases, topics, and/or categories in the fax document(s) that will be used to find relevant messages (ads). One or more relevant messages (ads) may be selected to be placed into the fax document(s) (Step 625).

One or more relevant messages (ads) may be incorporated with the fax document(s) (Step 630). The messages (ads) may be incorporated with the fax document(s) by adding one or more pages with the messages to the document(s), by placing the messages into a white space of the document(s), by placing the messages in the page margins of the document(s), by resizing some or all content of the document(s) and placing the messages into a white space, by placing the messages on the page(s) as watermarks, and/or by other methods. Additionally, the messages (ads) may be positioned in proximity to the significant terms, keywords, key-phrases, topics, and/or categories that were used to select the relevant message. The proximity may mean that the message is placed on the same page, or with a particular distance from the keyword (or a paragraph where it appeared), or on a white space closely located to the keyword (or closely located to a paragraph where the keyword appeared). If there are multiple white spaces in proximity to the keyword (or the paragraph), the largest white space may be used. FIG. 11 illustrates various sample placements of the message in the document. The messages (ads) may contain text and/or graphics. Some messages may be comprised of a single graphic. The messages may be resized to fit appropriately in the white spaces, page margins, or on the pages.

Further, the document(s) may be converted to one or more computer files (Step 635). The computer files(s), with one or more incorporated messages (ads), may be delivered to the Recipient (Step 640). The computer files(s) may be delivered to the Recipient via the Internet or other communication channels. The computer files(s) may be delivered to the Recipient through a variety of mediums, such as an I-Fax-compliant device able to receive the computer file(s) from the FSP, an email, a website where the Recipient may view his/her facsimile, a software that delivers the computer file(s) to the Recipient's computer, any combination thereof, equivalents thereof, and other mediums.

The steps of the method described in FIG. 6 may be performed in a different order. For example the text may be extracted from the fax document(s) (Step 615) prior to determining Recipient's properties at Step 610.

Alternatively, the fax document(s) may be converted to the computer file(s) prior to incorporating the messages (ads) with the fax document(s). The messages (ads) may then be incorporated into the computer file(s).

Additionally, the computer file(s) may be delivered to the Recipient with the text extracted from the fax document(s). For example the extracted text may be placed in the body of the email message and the facsimile (computer files) may be attached to the email message. Thus, the faxes may become more easily searchable using the text extracted from the fax document(s).

Additionally and/or alternatively, the relevancy of the messages may be determined based on text extracted from a previously sent and/or received facsimile, and/or based on the Sender's and/or Recipient's properties of a previously sent and/or received facsimile.

Further, the computer file(s) may be delivered to the Recipient with unincorporated message(s) (ads). The unincorporated messages are not incorporated into the facsimile or to the computer files. The unincorporated messages (ads) may be selected randomly or as a function of the text extracted from the fax document(s), text extracted from previously sent and/or received facsimile, the Sender's properties, and/or Recipient's properties. Thus, unincorporated messages (ads) may be relevant to text extracted from the fax document(s), the Sender's properties, and/or Recipient's properties. The unincorporated messages (ads) may be delivered to the Recipient as a body of an email, attachments to the email, graphics or text on a webpage displaying the computer files with facsimile message, etc.

In the situation when both the Sender and the Receiver use the same or different FSPs, the Recipient's FSP may check if the messages (ads) were already incorporated into the outgoing fax and thus may or may not include a second set of messages (ads) into the Recipient's incoming fax. If the Sender and the Receiver use the same FSP, the FSP may decide at which point to incorporate a single set of messages (ads) into the facsimile.

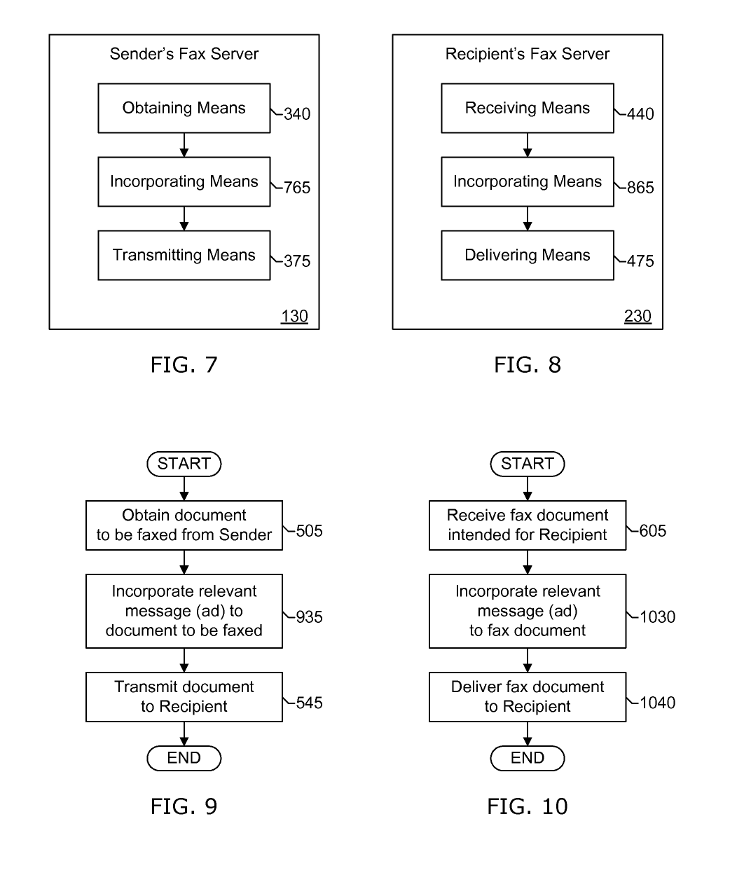

Referring to FIG. 7, another sample embodiment of the Sender's Fax Server 130 may comprise a Means for Obtaining the documents to be faxed from the Sender 105 (Obtaining Means 340), a Means for Incorporating relevant messages with the documents (Incorporating Means 765), and a Means for Transmitting the facsimile to the Recipient 135 (Transmitting Means 375).

The Incorporating Means 765 is one or more computers, devices, circuitry, and/or hardware, or equivalents thereof, optionally programmed with logical instructions, for incorporating relevant messages with the facsimile.

Another sample method for incorporating relevant messages (ads) with an outgoing facsimile is shown in FIG. 9. One or more documents may be obtained from a Sender (Step 505). One or more relevant messages (ads) may be incorporated with the document(s) (Step 935). The document(s), with one or more incorporated messages (ads), may be transmitted to a Recipient (Step 545).

Referring to FIG. 8, a sample embodiment of the Recipient's Fax Server 230 may comprise a Means for Receiving facsimile document(s) (transmissions) from the Sender 205 (Receiving Means 440), a Means for Incorporating relevant messages with the facsimile documents (Incorporating Means 865), and a Means for Delivering the facsimile documents to the Recipient 235 (Delivering Means 475).

The Incorporating Means 865 is one or more computers, devices, circuitry, and/or hardware, or equivalents thereof, optionally programmed with logical instructions, for incorporating relevant messages with the facsimile documents.

Another sample method for incorporating relevant messages (ads) with an incoming facsimile is shown in FIG. 10. One or more fax documents intended for a Recipient may be received (Step 605). One or more relevant messages (ads) may be incorporated with the fax document(s) (Step 1030). The fax document (s), with one or more incorporated messages (ads), may be delivered to the Recipient (Step 1040).

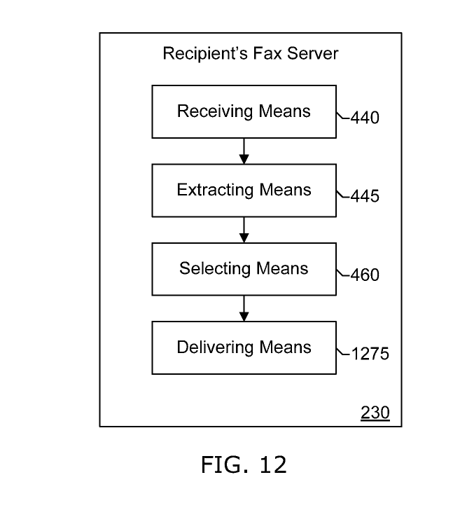

FIGS. 12-14 demonstrate sample system and methods for presenting unincorporated relevant messages to the Recipient. The unincorporated relevant messages may be added to an email message that delivers the facsimile to the Recipient or may be displayed on a website alongside with the facsimile.

Referring to FIG. 12, a sample embodiment of the Recipient's Fax Server 230 may comprise a Means for Receiving facsimile from the Sender 205 (Receiving Means 440), a Means for Extracting text from the facsimile (Extracting Means 445), a Means for Selecting one or more relevant messages to be presented to the Recipient 235 with the facsimile (Selecting Means 460), and a Means for Delivering the facsimile and Presenting the relevant messages to the Recipient 235 (Delivering Means 1275).

The Delivering Means 1275 is one or more computers, devices, routers, hubs, circuitry, and/or hardware, or equivalents thereof, optionally programmed with logical instructions, for delivering (or otherwise presenting) the facsimile to the Recipient 235 and for presenting the relevant messages to the Recipient 235. The Delivering Means 1275 may deliver the facsimile and the relevant messages to the Recipient 235 via a computer network.

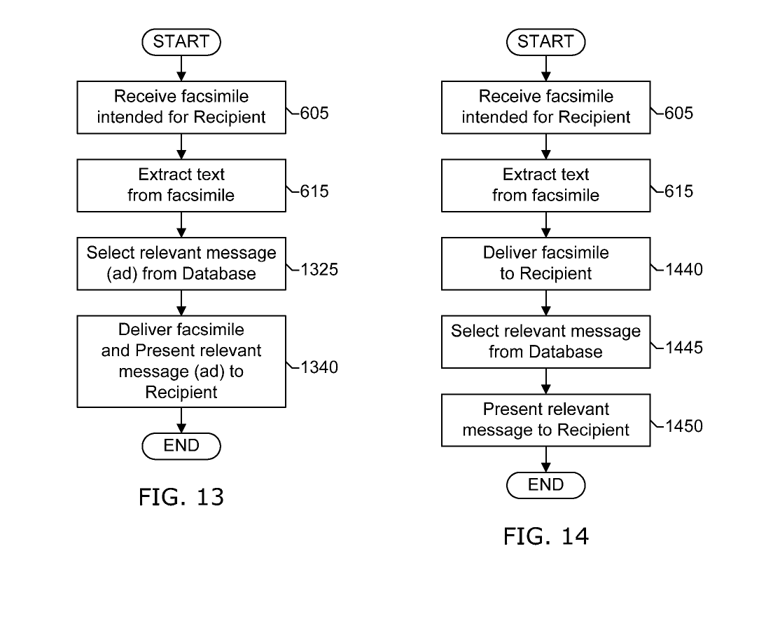

A sample method for presenting relevant messages (ads) with an incoming facsimile is shown in FIG. 13. One or more facsimile intended for a Recipient may be received (Step 605). Text may be extracted from the facsimile (Step 615). One or more relevant messages (ads) may be selected to be presented to the Recipient (Step 1325). The facsimile may be delivered to the Recipient and one or more relevant messages (ads) may be presented to the Recipient (Step 1340).

The relevant messages (ads) may be selected at the point when the Recipient views the facsimile. Thus, different messages may be presented to the Recipient at different times.

Another sample method for presenting relevant messages (ads) with an incoming facsimile is shown in FIG. 14. One or more facsimile intended for a Recipient may be received (Step 605). Text may be extracted from the facsimile (Step 615). The facsimile may be delivered to the Recipient (Step 1440). One or more relevant messages (ads) may be selected to be presented to the Recipient (Step 1445). One or more relevant messages (ads) may be presented to the Recipient (Step 1450).

Various methods and systems may be used for determining the relevancy of the messages (ads) to the facsimile. Some examples are provided in the following patent application publications, which are incorporated hereby in their entirety by reference: U.S. Pat. App. Publ. No. 2004/0059708 entitled Methods and apparatus for serving relevant advertisements, U.S. Pat. App. Publ. No. 2004/0093327 entitled Serving advertisements based on content, U.S. Pat. App. Publ. No. 2004/0059712 entitled Serving advertisements using information associated with e-mail, U.S. Pat. App. Publ. No. 2005/0071224 entitled System and method for automatically targeting web-based advertisements, U.S. Pat. App. Publ. No. 2005/0131758 entitled Systems and methods detecting for providing advertisements in a communications network, U.S. Pat. App. Publ. No. 2005/0065806 entitled Generating information for online advertisements from Internet data and traditional media data, U.S. Pat. App. Publ. No. 2005/0144069 entitled Method and system for providing targeted graphical advertisements, U.S. Pat. App. Publ. No. 2005/0222903 entitled Rendering content-targeted ads with e-mail, and U.S. Pat. App. Publ. No. 2005/0251444 entitled Facilitating the serving of ads having different treatments and/or characteristics, such as text ads and image ads.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention. The elements, steps, and limitations recited in the specification must not be read into the claims.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

The invention claimed is:

1. A system for incorporating relevant messages into an incoming facsimile, comprising:
a) a Means for Receiving a first facsimile and a second facsimile intended for a Recipient,
b) a Means for Extracting a text from said first facsimile,
c) a Means for Analyzing said text,
d) a Means for Storing one or more relevant messages,
e) a Means for Selecting said relevant messages for incorporating in said second facsimile, wherein a relevancy of said messages is determined, at least in part, as a function of said text,
f) a Means for Incorporating said relevant messages in said second facsimile, and
g) a Means for Delivering said first facsimile and said second facsimile to said Recipient.

2. The system of claim 1, wherein said Means for Analyzing includes an ability to determine significant terms, keywords, key-phrases, topics, and/or categories in said text.

3. The system of claim 1, wherein said Means for Storing includes an ability to store one or more terms, keywords, key-phrases, topics, and/or categories associated with said relevant messages.

4. The system of claim 1, wherein said Means for Storing includes an ability to store one or more geographical locations associated with said relevant messages.

5. The system of claim 1, further comprising:
h) a Means for Converting said first facsimile and/or said second facsimile into one or more computer files.

6. The system of claim 1, wherein said first facsimile and/or said second facsimile is received via the PSTN.

7. The system of claim 1, wherein said first facsimile and/or said second facsimile is delivered to said Recipient via an I-Fax-compliant device.

8. The system of claim 1, wherein said first facsimile and/or said second facsimile is delivered to said Recipient via an email.

9. The system of claim 1, wherein said first facsimile and/or said second facsimile is delivered to said Recipient via a website.

10. The system of claim 1, wherein said first facsimile and/or said second facsimile is delivered to said Recipient via a software.

11. The system of claim 1, wherein said Means for Extracting includes an ability to apply Optical Character Recognition to said facsimile to extract said text.

12. The system of claim 1, wherein said relevancy of said messages is further determined as a function of a Sender's property.

13. The system of claim 12, wherein said Sender's property comprises a Sender's geographical location.

14. The system of claim 1, wherein said relevancy of said messages is further determined as a function of a Recipient's property.

15. The system of claim 14, wherein said Recipient's property comprises a Recipient's fax number.

16. The system of claim 14, wherein said Recipient's property comprises a Recipient's geographical location.

17. The system of claim 14, wherein said Recipient's property comprises a Recipient's name.

18. The system of claim 1, wherein said system is maintained by a Fax Service Provider.

19. A method for incorporating relevant messages into an incoming facsimile, comprising the steps of:
a) receiving a first facsimile from a first Sender,
b) extracting a text from said first facsimile,
c) analyzing said text,
d) delivering said first facsimile to a Recipient,
e) receiving a second facsimile from a second Sender,
f) selecting one or more relevant messages for incorporating in said second facsimile, wherein a relevancy of said messages is determined, at least in part, as a function of said text,
g) incorporating said relevant messages in said second facsimile, and
h) delivering said second facsimile to said Recipient.

20. The method of claim 19, wherein said first Sender and said second Sender are the same person or entity.
